(19) United States
(12) Patent Application Publication
(10) Pub. No.: US 2011/0178932 A1
(43) Pub. Date: Jul. 21, 2011

(54) ARTISTIC WORK DOWNLOAD TRANSACTION (AWDT)

(76) Inventor: Anthony Kevin Johnson, (US)

(21) Appl. No.: 12/688,271

(22) Filed: Jan. 15, 2010

(51) Int. Cl. H04L 9/32; G06Q 30/00; G06Q 20/00; G06Q 50/00; G06Q 40/00

(52) U.S. Cl. 705/53

(57) ABSTRACT

A method for providing a pay-direct-to-owner (PDO) online transaction monetization service, for products and services delivered by online download, email, postal service mail, commercial delivery service, pick-up or performance on-site, utilizing web-based server systems to interface with telecom, wireless, satellite and cable internet service provider (ISP) company systems, separately or in concert, to process and close sales transactions transferring absolute ownership rights, initiated from any online location or website using any internet connected device. This business method will protect and monetize downloadable digital files and other products offered for sale online by systematically collecting payment for online purchases from ISPs and directing those payments to a product owner through a third-party online transaction payment collection conduit.

### FIELD OF THE INVENTION

The invention relates generally to electronic telecom commerce, and more specifically to a method for collecting and distributing point-of-sale (POS) payments for internet files downloaded by the public on any data network and providing a pay-direct-to-owner (PDO) payment solution.

### BACKGROUND OF THE INVENTION

Digitized music, video, artwork, photos, news, and software are downloaded and used without permission by Internet users to the dismay of intellectual property rights holders. Business models that rely on controlling IP and charging high prices for its use are being challenged by free IP services which are supported by advertising fees and service contracts. Music, video, news, and software are not going away. However, the business models are quickly changing. Entrenched market leaders continually fail to make timely transitions to new technology and business models necessary to adapt and profit from constant innovation and social change.

### PRIOR ART OF THE INVENTION

While illegal downloading may be popular, many are turning to such legal internet sources for their music. Recently, NPD, a market research company, announced that iTunes' digital music sales in the first two quarters of 2009 had accounted for 25 percent of total CD sales in the US. The other top leaders in CD sales, Wal-Mart, Best Buy, Target and Amazon, lagged behind iTunes with 20, 16, 10 and 10 percent shares respectively in the U.S. CD market. In addition, iTunes' music sales now represent 69 percent of the U.S. digital music market. Amazon MP3, iTunes' biggest competitor, only accounted for eight percent of U.S. digital music and movie sales. While this is helping with the legal distribution of digitized product, this does nothing to prevent the use of illegal and highly popular file sharing sites and programs. Audity was invented to eliminate illegal file sharing and software piracy while increasing profitability for web content owners who sell online.

### SUMMARY OF THE INVENTION

In summary, the present invention relates to a method for collecting and distributing point-of-sale (POS) payments for internet file downloads by encoding media files with tags that transmit secure sales transaction data packets which are fulfilled by telecom, wireless, satellite and cable ISP customer account billing systems. Audity is a direct-to-owner file download monetization process that bypasses traditional online third-party financial transaction services by directing point-of-sale payments exclusively to a buyer's cable, telecom, wireless, or satellite company server-side customer account billing systems, then collecting from all ISP's, and then distributing the gross sales proceeds directly to the registered owners of the downloaded files.

The present invention is also a method for collecting and distributing point-of-sale payments for Internet file downloads by the public at large, directly to the file owner through utilization of a payment collection conduit which collects sales proceeds from all ISPs and pays the file owners buy crediting their Audity cash account maintained by the authorized collection conduit.

### BRIEF DESCRIPTION OF THE DRAWINGS

FIG. 1 is a perspective diagram of a digital download sales network wherein any connected device (OD) such as a computer or cell phone can purchase and download music, movies, photographs, artwork, books and other files by simply downloading the product and paying their monthly internet/phone bill.

FIG. 2 is a perspective diagram of the internet file download point-of-sale (POS) data flow starting with the buyer/downloader/end user, to the ADC for code authorization, and terminating the transaction at the ISP for billing and collections.

FIG. 3 is a perspective diagram of the internet service provider's packet switched network as it pertains to the services being offered by the authorized conduit via Audity. Packet switching is a rapid store-and-forward networking design that divides messages up into arbitrary packets, with routing decisions made per-packet. The file has a header that contains information pertaining to the contents of the file, such as the destination address, how large the file is (how many packets to expect), and billing information as needed. The payload (file content such as music or video, etc) comes next and then the trailer which is basically for error correction.

### DETAILED DESCRIPTION OF THE INVENTION

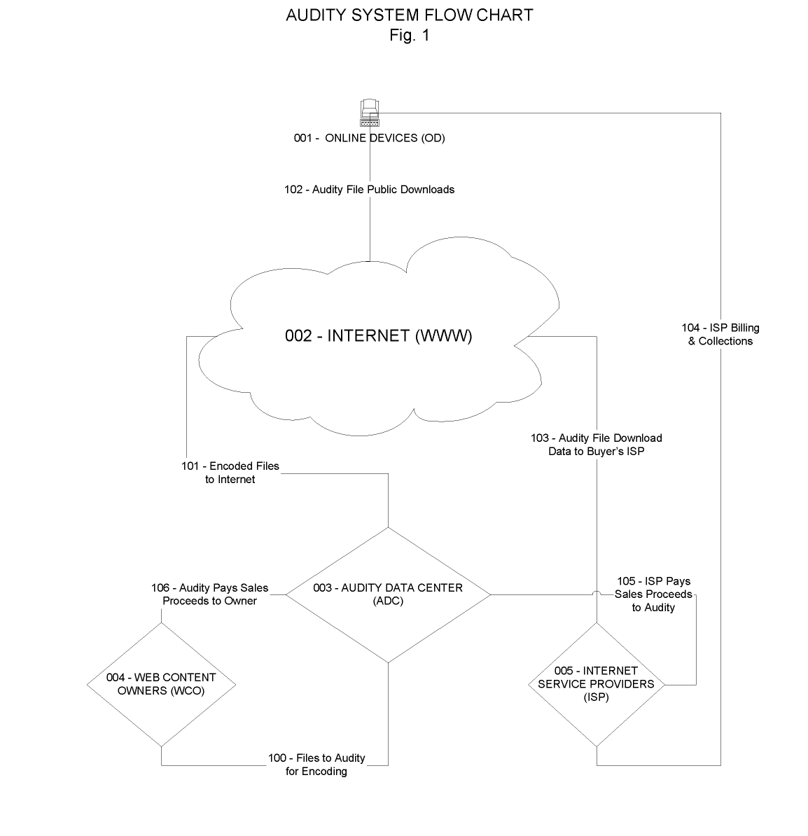

FIG. 1 provides a simplified illustrative representation of the process for computer file (OD) download monetization that bypasses traditional transfers of credit card or bank information to make payment 104 for absolute ownership rights. As described herein, the present invention allows web content owners (WCO) to register and encode files 100 on the Audity website (ADC) which encrypts the file with information such as owner code, price, preview location, conduit ISP account codes and all other pertinent packet info to be made available online 101 then received and processed 103 by the buyer's internet service provider (ISP) upon purchase. When a customer (OD) downloads an ADC encoded file from the internet (WWW) 102 the buyer's ISP receives the packet info 103 with all transaction details and then bills the buyer 104 through the ISP's normal billing systems. The ISP then remits all monies received 105 to the ADC for distribution 106 to the owners (WCO) of the purchased files downloaded.

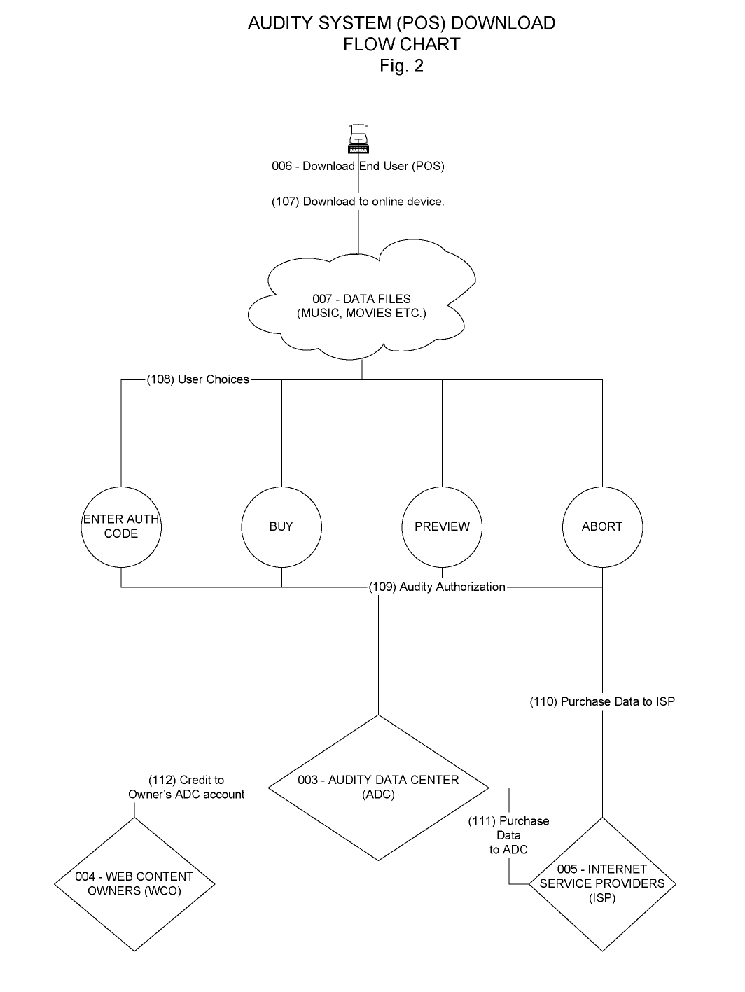

FIG. 2 provides a simplified illustrative representation of the point-of-sale (POS) transaction details beginning with the end user 006 who downloads 107 an Audity encoded file 007 from any available network. After end user 006 downloads the file and clicks on it, an Audity payment screen is displayed for end user to 108 enter their previously purchased file authorization code (ENTER AUTH CODE); or to buy the file through their ISP (BUY); or to preview the file before purchase (PREVIEW); or to close and delete the file from their hard drive (ABORT). After making a selection 108 the information packet is sent 109 to the ADC 003 and the ISP 005 simultaneously for processing 110 and a sale confirmation 111 is transmitted to the ADC 003, and the ADC 003 then credits 112 the owner's (WCO) 004 registered (ADC) 003 cash account.

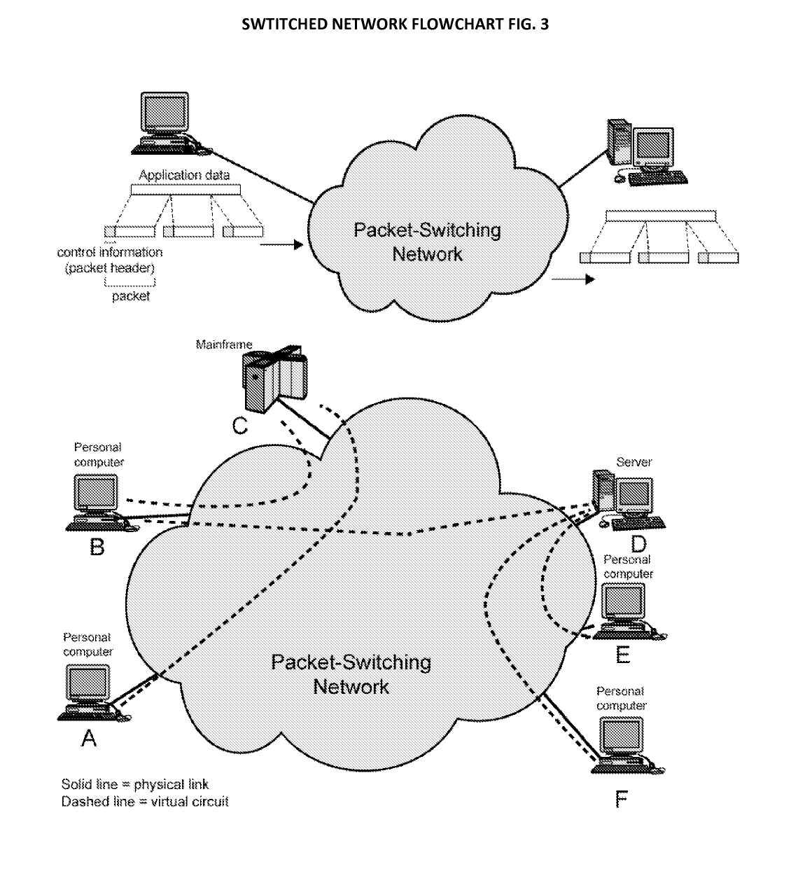

FIG. 3 provides a simplified illustrative presentation of the process for file identification and processing by the internet service providers and their packet switched network. The file is consisted of a header, payload and trailer. Each packet's header will contain the proper protocols, the originating address (the IP address of your computer), the destination address (the IP address of the computer where you are sending the file) and the packet number. Routers in the network will look at the destination address in the header and compare it to their lookup table to find out where to send the packet. Once the packet arrives at its destination, the computer will strip the header and trailer off each packet and reassemble the file based on the numbered sequence of the packets.

What is claimed is:

1. A method for providing a pay-direct-to-owner (PDO), online sale transaction monetization service, not involving payment or collection of any type of royalties and without a buyer using any type of credit card, debit card, bank account or other internet payment processing business, to close online point-of-sale (POS) purchase transactions transferring absolute ownership rights including subscriptions, but not including licensing rights of any kind, between independent buyers and sellers of products and services delivered by online download, email, postal service mail, commercial delivery service, pick-up or performance on-site, utilizing web-based server systems to interface with telecom, wireless, satellite and cable internet service provider (ISP) company systems, separately or in concert, initiated from any online cloud location, internet device or website, comprising the following steps:
(A) registering a person or a company as account owner and entering relevant transaction specific information itemized in step “B” of claim 1, on a product offered for sale online on a payment collection conduit database form, website or software program;
(B) uploading a digital file product including a audio or video clip sample, or a digital image file representing a physical product or service, to a payment collection conduit's website or software program for encoding and encrypting a product file with a secure encrypted proprietary data tag identifying a product type, name, size, item number, product specification, multiple purchase discount, product authorization code, ISBN, coupon code, promotion code, UPC bar code number, EAN bookland bar code number, UCC bar code number, SC-14 bar code number, UCC 128 or EAN 128 bar code number, retail price, wholesale price, wholesale discount amount, retail discount amount, country of sale, product OEM-serial-part number, product delivery options, seller or owner's conduit account payable number, seller or owner's conduit company registration number, if applicable, and any required proprietary information or codes to be determined, developed, created or issued by a internet service provider or conduit company to communicate with transaction servers to process online sales;
(C) downloading and clicking on a conduit encrypted product file residing online or on a internet device to purchase a product, thereby opening a product purchase payment prompt screen disclosing a product price and buyer information data input fields to verify file encoding;
(D) uploading a conduit encoded product file, which is not a widget or any similar type software, to sell from a computer cloud, website or device connected to the internet:
(E) accessing encoded file by end-user buyer and clicking on a conduit encrypted product file residing online or on a internet device to purchase a product, thereby opening a product purchase payment prompt screen disclosing a product price, a authorization code input field and “Buy”, “Preview” and “Abort” selection buttons;
(F) clicking on “Preview” to review a product, or “Buy” to purchase a product, or “Abort” to close a payment prompt screen, or entering a product authorization code to open a previously purchased digital product on a new device;
(G) inputting a buyer's information, not including credit card or debit card or bank account or any other payment service information, into data fields then clicking on “Buy” thereby initiating transmission of data packets communicating product and payment information to a buyers ISP and a product owner's conduit company for closing, and thereafter a transaction validation response approval authorization code is transmitted to a buyer's purchase payment prompt screen automatically populating the authorization field with a code, which is not executable if stored on any external dongle or similar type data storage device for product file security reasons, or a code is emailed to a buyer for manual input and purchased file information packets are received and processed by a buyer's ISP company where a purchase amount and transaction detail is added to a buyers monthly ISP bill;
(H) paying buyer's ISP bill;
(I) transferring a transaction payment amount from a buyer's ISP, minus associated ISP fees if any, to a seller's conduit company;
(J) crediting a registered file seller's conduit account for a payment amount collected, minus associated conduit fees if any.

2. The method of claim 1 further consists of utilizing any foreign language translation and currency conversion software to enable the Audity Process to interface with alien ISP networks.
